(19) United States
(12) Patent Application Publication
(10) Pub. No.: US 2012/0055073 A1
(43) Pub. Date: Mar. 8, 2012

(54) Insect catching method and apparatus

(76) Inventor: Robert Darby, The Hague (NL)

(21) Appl. No.: 13/296,479

(22) Filed: Nov. 15, 2011

(30) Foreign Application Priority Data
Jul. 12, 2010 (GB) GB1011622.6

(51) Int. Cl. A01M 1/06; A01M 1/04; A01M 1/10

(52) U.S. Cl. 43/107; 43/139; 43/113

(57) ABSTRACT

The best results are produced by approaching the insect 13 with the open end of inner tube 10B of the apparatus pointing towards the insect 13, from a distance which does not frighten the insect into flying or crawling away, such that the positive airflow indicated by the arrows A approach the surface 12 on which the insect 13 rests. In the same movement the open end of inner tube 10B is brought closer and closer to the insect 13, thus increasing the positive air-pressure on insect 13. The insect 13 that is pinned to the surface 12 on which it has rested due to the positive air-pressure indicated by the arrows A, is then vacuumed into inner tube 10B, due to the vacuum effect of the negative air-pressure indicated by the arrows B.

The present invention relates to an environmentally friendly, energy efficient and swift insect catching method and apparatus.

### CROSS-REFERENCE TO RELATED APPLICATIONS

This is a U.S. patent application based upon U.K. application No. GB 1011622.6, filed Jul. 12, 2010.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING, A TABLE OR COMPUTER PROGRAM

Not Applicable

### BACKGROUND OF THE INVENTION

Millions of people all over the world are bothered, inconvenienced or endangered by flying and crawling insects in their homes, offices or in their tents and caravans. Some of these insects are capable of inflicting painful stings or bites. In the case of some insects, these stings or bites can have very serious consequences to people's health and can even result in death. Other insects are unhygienic in the direct environment of people and food.

Various methods are used to minimise the problems and nuisance created by insects. Invariably, these methods lead to the unnecessary killing or maiming of the insects. These methods vary from the spreading or spraying of poisonous chemicals or insecticides, sticky fly paper, entrapment, electrocution and the swatting or squashing of insects with numerous types of instruments or apparatus readily available in the home or in the shops.

The most commonly used method of removing unwanted insects in the working or living environment, is to swat the insect with a swatting instrument. When effective, this frequently used method to maim or kill insects such as spiders, flies, mosquitoes, wasps and bees, invariably leaves nasty stains and quite often leads to objects, valuable or not, being damaged or broken during the attempt to swat the insect.

Some of the methods used in the attempt to exterminate insects, result in a swift death. However, this is not always the case, quite often the insects are subjected to a slow and painful death through poison, hunger, thirst or mutilation.

There are people that take affront to the methods used to exterminate insects or disagree with the fact that insects are being exterminated, preferring to catch the insects unharmed and release the insects in a location where they are no longer a danger, nuisance or inconvenience.

Some insects make a positive contribution to people's life's in some form or other, due to the role of insects in the pollination of plants and the environmentally friendly way in which insects dispose of waste and as is the case of bees in the production of honey.

For the collection and study of insects it is important not to damage the insects. There are many methods used for this purpose, varying from nets, baited traps and even glass jars. Invariably these methods are slow with a limited success rate and often result in the insect moving away before it can be caught or the insect being damaged in some form or other.

Flying insects are especially hard to catch. Catching a flying insect in flight necessitates a fast reaction and invariably takes time and many attempts before the flying insect is actually caught. A far more efficient method is to catch a flying insect as it rests on a surface such as a windowpane, table, floor, wall, ceiling, vase, tree or plant etc. Even this method is difficult due to the fast reaction of the flying insect. Most insects and especially flying insects are very skittish and sense the approach of an insect catching apparatus or instrument and will more often than not move or fly away before it is possible to catch the insect.

There are numerous vacuum based apparatus used in the attempt to catch insects. Invariably these apparatus are not effective in that insects tend to sense the approach of an insect catching-apparatus or instrument and move or fly away before the apparatus can utilise the vacuum effectively. As is the case with battery driven apparatus, the battery power is wasted due to the many attempts needed to catch an insect, and the number of insects caught with an installed battery or batteries is thus greatly reduced, resulting in a continual replacement or recharging of the battery or batteries. This is a waste of energy and batteries.

Some existing vacuum based insect catching apparatus collect the insects in a containment area of the apparatus, necessitating the manual removal or reversal of the containment section to allow for disposal or freeing of the insects. However, many people have reservations about manually handling containers with insects and prefer to keep the insects at a reasonable distance when catching, releasing or disposing of the insects.

Other known vacuum based insect catching apparatus are too slow, relying on debilitating fumes to disorientate the insect before allowing the vacuum section of the apparatus to vacuum the insect into a containment area. This method delivers unwanted fumes into the environment and can damage the insect.

The present invention seeks to overcome or reduce the harm, nuisance or inconvenience caused by insects and to reduce one or more of the above disadvantages of existing methods.

### BRIEF SUMMARY OF THE INVENTION

According to the first aspect of the invention there is provided a method for catching and undamaged collection of live none flying and flying insects on surfaces, whereby at the same time and in one (1) movement, positive air-pressure is used to pin an insect to the surface on which it rests and negative air-pressure is used to vacuum the pinned insect into a containment area.

According to the second aspect of the invention there is provided an apparatus for catching and undamaged collection of live none flying and flying insects on surfaces, whereby the insect(s) are contained in a containment area offering the choice of viewing the insect(s) and then, either the swift release of the insect(s) unharmed or the extermination of the insect(s) in a humane manner.

Advantages offered by the above insect catching method and apparatus are in particular that it allows the apparatus to be positioned at a distance from the insect, which does not frighten the insect into flying or crawling away which is then followed by catching the insect in one movement. The catching and release of the insect(s) does not damage or harm the insect. The apparatus does not touch the surface on which the insect rests. The operator of the insect catcher has the choice of freeing the caught insect(s), unharmed back into the environment or exterminating the insects(s) in a humane manner without manually handling the insect(s) or manually handling the containment area.

The apparatus allows for the catching of insects on all surfaces, including floors, walls, curtains, vases and ceilings and normally inaccessible places, such as high-walls or ceilings and at practically all angles.

Due to the swiftness and effectiveness of this method, the battery power is used effectively, resulting in a minimum use of energy and thus a minimum renewal of batteries and/or energy needed to recharge the batteries. This energy efficiency results in the catching of many more insects than existing methods with one and the same battery or batteries.

Preferred embodiments of the present invention will now be described by way of example only, with reference to the accompanying drawings, indicating the various steps in the capture of an insect and release of an insect(s):

### BRIEF DESCRIPTION OF THE SEVERAL VIEWS OF THE DRAWINGS

FIG. 1 is a perspective view of the overall insect catching apparatus.

FIG. 2 is a longitudinal cross-sectional view through the apparatus in the insect catch position.

FIG. 3 is a longitudinal cross-sectional view through the apparatus in the insect release position.

FIG. 4 is a cross-sectional view of the basic housing 6 of the apparatus, and the airflow within said housing.

FIG. 5 is a cross-sectional view of the adjustable connection 8 of the apparatus in the insect catch position.

FIG. 6 is a horizontal cross-sectional view through the line 11-11 through the apparatus shown in FIG. 1.

FIG. 7 is a horizontal cross-sectional view through the line 18-18 through the apparatus shown in FIG. 1.

FIG. 8 is a cutaway view of the air-intake and air-exhaust area of the apparatus in the catch mode, including deflectors 10D.

FIG. 9 is a cutaway view of the two-directional valve 14 area.

FIG. 10 is a cutaway view of the air-intake and air-exhaust area, where the transition from two half tubes (See FIG. 6) to two tubes, one (1) inside the other (See FIG. 7) is shown.

FIG. 11 is a cross-sectional view through the centrifugal impeller 7 and the airflow created by said impeller.

FIG. 12 is a cross-sectional view through the alternative mounting of centrifugal impeller 7 and electric battery operated motor 5.

FIG. 13 is a cross-sectional view through a horizontally placed impeller in the basic housing 6.

FIG. 14 is a perspective view of the overall insect catching apparatus with adjustable handle 2 in a modified position of ninety (90) degrees to the main body of the apparatus.

FIG. 15 is a cross-sectional view through the upper section of a modified apparatus in the insect catch position showing an alternative airflow and high voltage grid.

FIG. 16 is a cross-sectional view through the upper section of the apparatus in the insect catch position showing a light source directional aid.

### DETAILED DISCRIPTION OF THE INVENTION

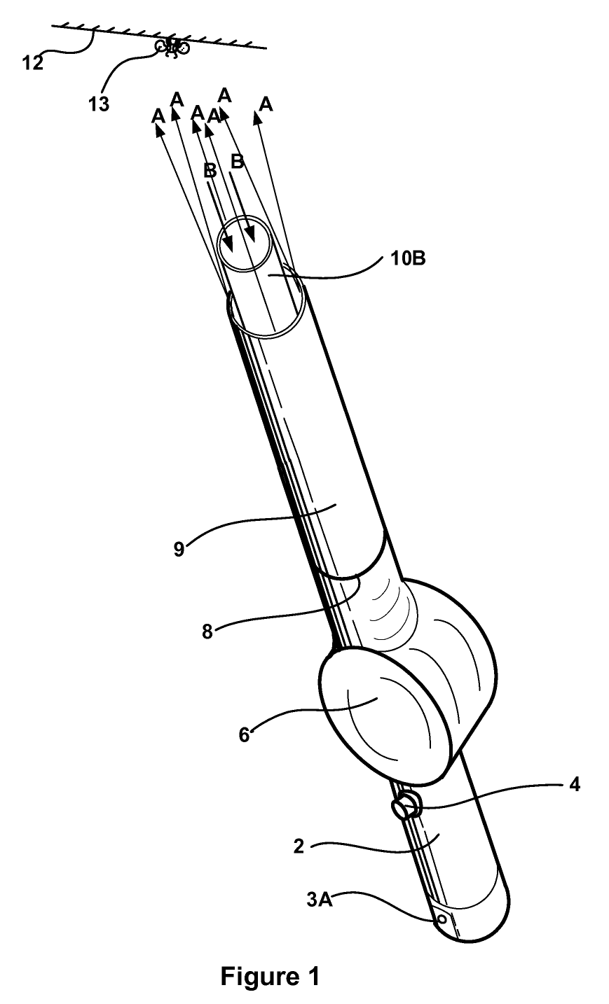

FIG. 1 shows the overall appearance of the insect catching apparatus, including a handle 2 with an on/off switch 4 and a battery pack release button 3A which releases a battery pack 3 (not shown in this drawing) that is connected to a basic housing 6 and an adjustable connection 8 for changing from the insect catch position to the insect release position. The upper open-ended section of the apparatus, including outer tube 9 and inner tube 10B show the direction of the airflow A and B when the apparatus is in the insect catch position. The insect 13 and surface 12, on which the insect 13 rests, gives an impression of the positioning of the overall apparatus towards the insect in the insect catch position.

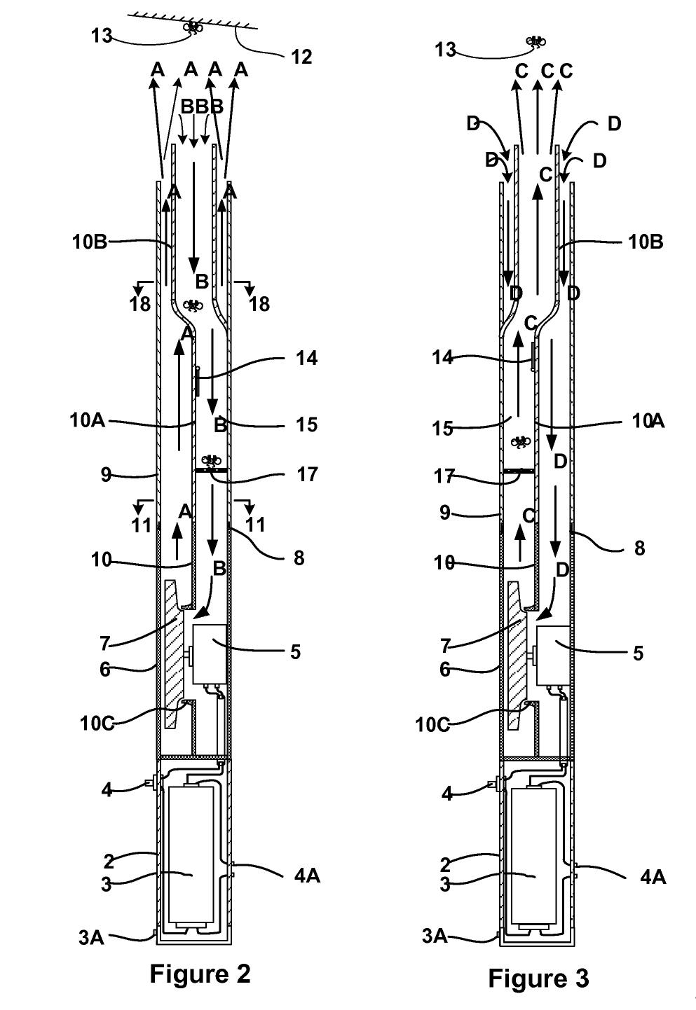

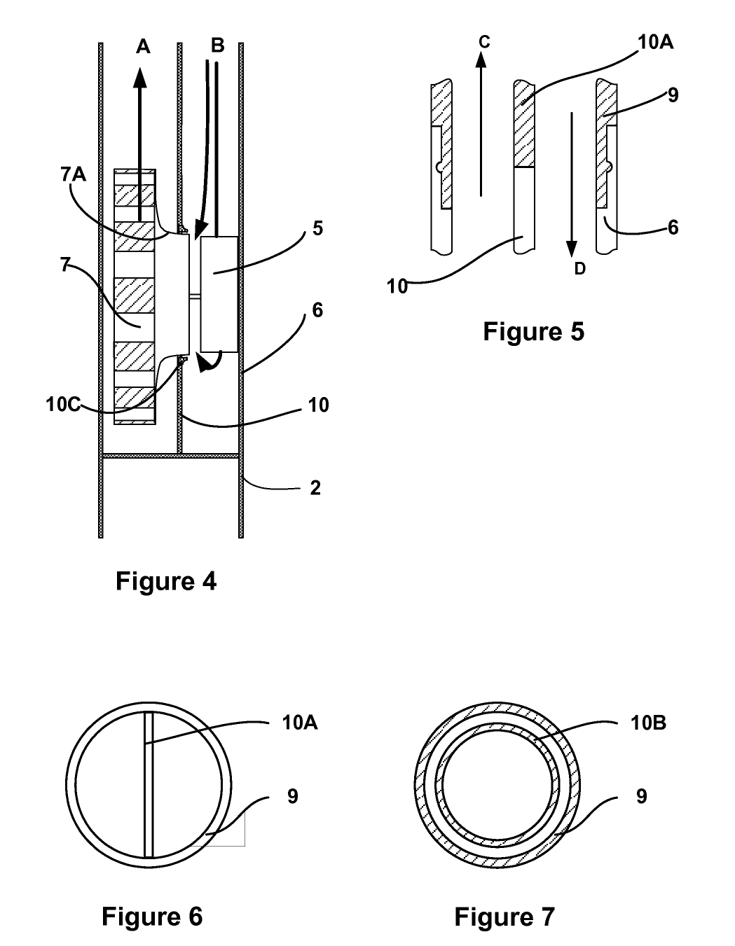

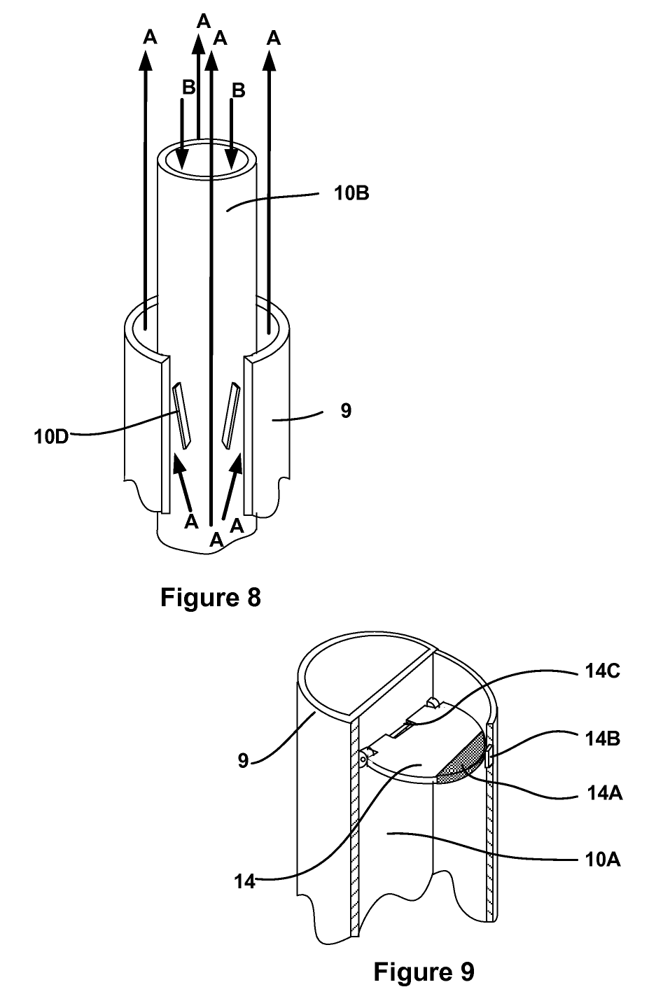

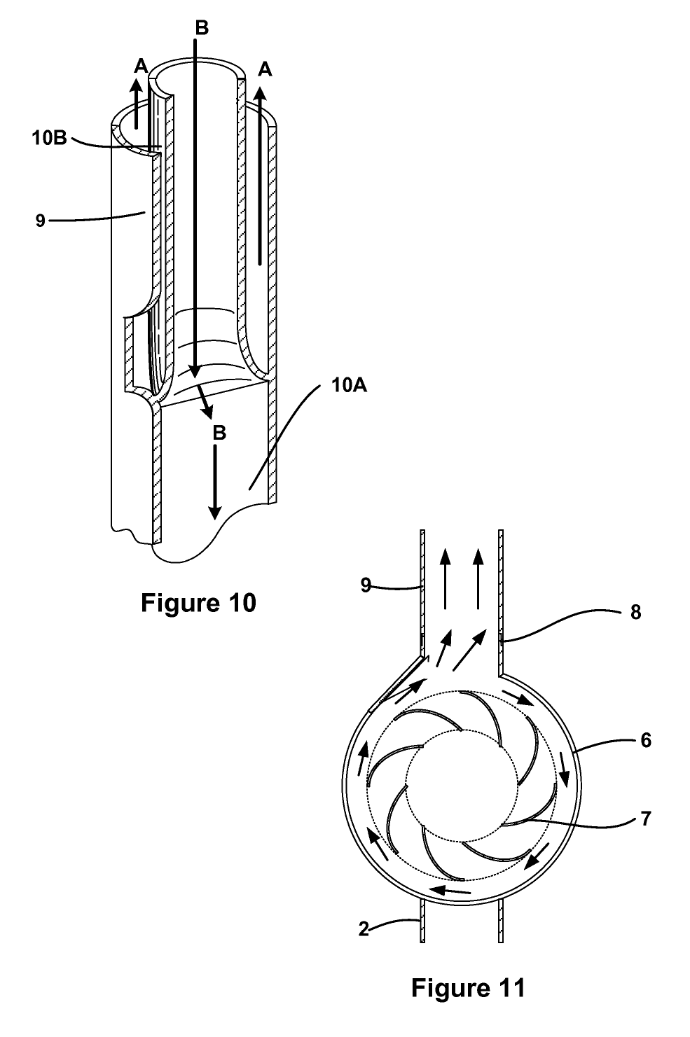

FIG. 2 shows a longitudinal cross-sectional view through the apparatus in the insect catch position. The arrows indicate the direction of the airflow. The overall housing of the apparatus is handled by handle 2. The handle 2 contains a none-rechargeable or rechargeable battery pack 3 having the recharge terminals or contacts 4A. The battery pack 3 can be removed from the handle 2 by battery pack release button 3A. An electric battery operated motor 5 is located within basic housing 6. The electric battery operated motor 5 is switched on and off by means of switch 4 on the side of the handle 2. The motor driven centrifugal impeller 7 is contained within basic housing 6 and is driven by the electric battery operated motor 5. The centrifugal impeller 7 is of the type commonly used in handheld vacuum cleaners and the rotation direction of the centrifugal impeller 7 is such that the maximum exhaust air is produced. The centrifugal impeller 7 is mounted to the electric battery operated motor 5 with the air-intake surface of the centrifugal impeller 7 facing the electric battery operated motor 5. Placing the centrifugal impeller 7 in the opposite direction than is the standard in most vacuum based apparatus, saves space and reduces the size of the basic housing 6. This method does not impair the air-intake of the centrifugal impeller 7. After switching the electric battery operated motor 5 on with switch 4 on the side of handle 2, the exhaust air indicated by arrow A, in the form of positive air-pressure from the centrifugal impeller 7 is expelled through the open area between basic housing 6 and divider 10 as shown in FIG. 4. Divider 10 divides the basic housing 6 into two physically separate areas. The exhaust air continuously flows through the open area between outer tube 9 and divider 10A. Divider 10A divides the outer tube 9 into two physically separate areas as shown in FIG. 6. The exhaust air continuously flows through the open area between outer tube 9 and inner tube 10B. Here, the two (2) half tubes formed by outer tube 9 and divider 10A are transformed from the two (2) half tubes, as shown in FIG. 6, into two (2) round tubes, one set within the other, as shown in FIG. 7 and FIG. 10. At this stage approximately fifty percent (50%) of the positive airflow is redirected by means of the deflectors 10D (see FIG. 8), such that the positive airflow is equally distributed in the area between outer tube 9 and inner tube 10B. Here the exhaust air in the form of positive air-pressure indicated by the arrows A is expelled in the direction of the insect 13 that rests on a surface 12.

After switching the electric battery operated motor 5 on with switch 4 on the side of handle 2, the best results are produced by approaching the insect 13 with the open end of inner tube 10B of the apparatus pointing towards the insect 13, from a distance which does not frighten the insect into flying or crawling away, such that the positive airflow indicated by the arrows A approach the surface 12 on which the insect 13 rests, at an angle of between twenty (20) degrees and ninety (90) degrees, depending on the surface on which the insect 13 rests. A laser apparatus or other light source may be placed in or on the apparatus to help direct the apparatus towards the insect. In the same movement the open end of inner tube 10B is brought closer and closer to the insect 13, thus increasing the positive air-pressure on insect 13. The insect 13 that is pinned to the surface 12 on which it has rested due to the positive air-pressure indicated by the arrows A, is then vacuumed into inner tube 10B, due to the vacuum effect of the negative air-pressure indicated by the arrows B. Due to the positive air-pressure, any dust or small particles on hard surfaces in the vicinity of the insect 13 are blown away before the vacuum effect is actually effective, thus avoiding the possibility of said dust particles being sucked into the apparatus and blocking the screen 17 which would reduce the airflow and thus the vacuuming effect. The insect 13 is drawn into inner tube 10B before inner tube 10B touches the surface 12 on which the insect 13 rests, usually at a distance of between one (1) millimetre and twenty five (30) millimetres for example for house flies mosquitoes, flies and wasps, depending on the size and combination of electric battery operated motor 5, centrifugal impeller 7 and the protrusion of inner tube 10B from outer tube 9.

The inner tube 10B extends beyond outer tube 9 to a certain extent thus avoiding the situation whereby all or most of the positive airflow indicated by the arrows A is drawn directly into inner tube 10B by the negative airflow indicated by the arrows B and thus cancelling the effect of the positive airflow indicated by the arrows A that is needed to pin the insect 13 to the surface 12 on which it rests. The protrusion of inner tube 10B from outer tube 9 is preferably between fifteen (15) millimetres and one hundred (100) millimetres, depending on the amount of positive airflow indicated by the arrows A and negative airflow indicated by the arrows B that is used to capture the insect. A greater positive airflow allows for a longer extension of inner tube 10B.

The negative airflow together with the insect 13 continues to flow through inner tube 10B and between outer tube 9 and divider 10A towards the containment area 15 due to the suction effect of the negative airflow indicated by the arrows B. The two-directional valve 14 that is held in the closed position due to the magnetic attraction of the iron strip 14A, that is attached to two-directional valve 14, towards the magnet 14B (see FIG. 9) of insect containment area 15 is forced open by the negative air-pressure indicated by the arrows B, allowing the insect 13 to be sucked into the containment area 15. The magnet 14B is either fixed to the inner or outer side of outer tube 9 or molded into de material forming outer tube 9. The section of outer tube 9 covering the containment area 15 is preferably made from a transparent material to allow viewing of contained insect(s). The containment area 15 may be modified to increase the amount of insects to be held. The containment area 15 may also be a removable section of the apparatus, for the purpose of studying the caught insects. Here the insect 13 is trapped by the negative air-pressure against screen 17. Experimentation has shown and proven itself that a Nylon fabric screen with apertures of between 0.5 to 1.3 millimetres is most effective in trapping the insect 13 without obstructing the airflow. The airflow continues through the open area between outer tube 9 and divider 10A and between basic housing 6 and divider 10 to the air-intake of centrifugal impeller 7. When switch 4 is turned off, the two-directional valve 14 of insect containment area 15 reverts to the closed position as the air-pressure is stopped and the iron strip 14A is magnetically attracted to the magnet 14B. The insect 13 is then contained within the containment area 15.

It is also possible to include a variable electric battery operated motor 5 and/or place opening shutters in the air-intake area and/or the air-exhaust area to allow variations in both or either the positive air-pressure and the negative air-pressure of the apparatus to suit the size and bodyweight of the insect to be caught. For example a small amount of air-pressure is applied for small insects such as mosquitoes, small-flies or spiders and ants. A large amount of air-pressure is applied for large insects such as wasps, bees, large-flies or spiders.

Although the length of the apparatus is such that an average adult can reach insects in most places within houses, offices, tents and caravans. It is also possible to include an elongated tubular section(s) to reach inaccessible areas such as very high ceilings. The tube(s) can consist of several lengths and different lengths or telescopic tubes. The elongated tubular section(s) or telescopic tubes can be connected to the basic housing 6 by way of a form fit or push fit coupling. Alternatively, the handle 2 can be elongated by means of a pole or a tube.

The actual shape of the area between outer tube 9 and divider 10, divider 10A and inner tube 10B can vary. The areas can be e.g. oval or square shaped as long as sufficient space is retained to allow a continuous flow of air and are large enough for the capturing and release of insects.

The overall size of the insect catching apparatus including the size and power of the electric battery operated motor 5 and size of the centrifugal impeller 7 can vary, depending on the usage, i.e. for the catching of large insects such as are found in tropical or subtropical regions of the world the overall size should be increased. And for the catching of small insects having the average size of mosquitoes and such like, the overall size should be decreased.

It is also possible to use separate batteries, separate or integrated switches or electronic circuits to vary the power, for the purpose of increasing and decreasing the positive air-pressure and negative air-pressure, e.g. when increasing positive air-pressure is needed to eject captured insects or to suit the size of the insect to be caught.

The electric battery operated motor 5 used can be of any kind, but preferably an electric motor, particularly one which is powered by (rechargeable) batteries.

The insect containment area and all areas used to eject the insect(s) should be smooth, such that the insects are readily removed from the containment area; it may be necessary to coat the area with a release agent, e.g. polytetrafluoroethylene for this purpose.

In designing the apparatus, in particular the tubes, care should be taken to optimise the airflow throughout the apparatus as much as possible, to avoid crevices or projections that would restrict the airflow and/or allow an insect the possibility of clinging onto protrusions in order to prevent its capture or ejection.

FIG. 3 shows a longitudinal cross-sectional view through the apparatus in the insect release position. The arrows indicate the direction of the airflow. The air-intake is shown by the arrows D. Changing the apparatus from the insect catch position to the insect release position is set by manually turning outer tube 9 with all its fixed internal connections one hundred and eighty (180) degrees clockwise or anticlockwise, as viewed from the handle 2 of the apparatus. This upper section of the apparatus is connected to the basic housing 6 by means of a close-fitting but freely rotatable adjustable connection 8 (see FIG. 5). Switching the electric battery operated motor 5 by means of switch 4 to the on position, allows for the release of contained insects. The exhaust air in the form of positive air-pressure from the centrifugal impeller 7 is expelled through the open space between basic housing 6 and divider 10, see airflow direction indicated by the arrow C. The exhaust air passes continuously through the screen 17 and the containment area 15 thus forcing the insect 13 towards the two-directional valve 14, which is forced open by the positive air-pressure passing through the open area between outer tube 9 and divider 10A. The air continues to flow though inner tube 10B, thus exhausting the insect 13 into the environment, see airflow direction indicated by the arrows C. When switch 4 is turned off, the two-directional valve 14 of insect containment area 15 reverts to the closed position as the air-pressure is stopped and the iron strip 14A that is connected to two-directional valve 14 is magnetically attracted to magnet 14B (see FIG. 9).

Turning now to FIG. 4, there is shown a relationship between the centrifugal impeller 7 and the divider 10. The centrifugal impeller 7 has an impeller skirt 7A extending from the planar surface of centrifugal impeller 7 which penetrates into the skirt 10C of divider 10 to some extent. This forms a more airtight formation between the centrifugal impeller 7 and divider 10. The rotation direction of the centrifugal impeller 7 is such that maximum air-intake into centrifugal impeller 7 is produced. The exhaust air from the centrifugal impeller 7 is expelled through the open area between basic housing 6 and divider 10 as indicated by arrow A.

Turning now to FIG. 5, there is shown the adjustable connection 8 in the insect catch mode. The fit between basic housing 6 and outer tube 9 should be close-fitting but flexible enough to allow for rotary adjustment. The divider 10 and divider 10A should fit tightly but flexible enough to allow the rotary adjustment.

Turning now to FIG. 8, there is shown the open end of the apparatus in the insect catch mode, with deflectors 10D that distribute the exhaust air in the form of positive air-pressure evenly between outer tube 9 and inner tube 10B as indicated by arrows A.

Turning now to FIG. 9, there is shown a relationship between the two-directional valve 14 that is attached to divider 10A with hinge 14C such that when the two-directional valve 14 is in the closed position, the half tube formed between outer tube 9 and divider 10A is blocked. The two-directional valve 14 automatically reverts to the closed position when electric battery operated motor 5 is switched off. This automatic closure of the two-directional valve 14 is due to the attraction of the iron strip 14A, that is attached to the two-directional valve 14, to the magnet 14B that is embedded in the surface of outer tube 9. Care should be taken to make sure that the magnet 14B is powerful enough and correctly positioned to be able to magnetically attract the two-directional valve 14 into the closed position when the electric battery operated motor 5 is turned off, even when the two-directional valve 14 is completely open, no matter in what position the insect-catcher is held. At the same time, care needs to be taken to make sure that the magnetic attraction of two-directional valve 14 to magnet 14B can be broken by either the positive air-pressure or the negative air-pressure used for catching and releasing insects. Experimentation has shown and proven itself that a small magnet such as a Viessmann 6841 as used by model train enthusiasts, measuring 10×5×1.5 millimetres is most effective in combination with an iron strip of similar size.

Turning now to FIG. 10, there is shown the open end of the apparatus in the catch mode, with the vacuumed air-intake indicated by arrow B, passing through inner tube 10B and passing the transition area from tube to half tube and into the area between outer tube 9 and divider 10A.

Turning now to FIG. 11, there is shown a relationship between the centrifugal impeller 7 and basic housing 6, revealing the airflow created by the centrifugal impeller 7 indicted by the arrows.

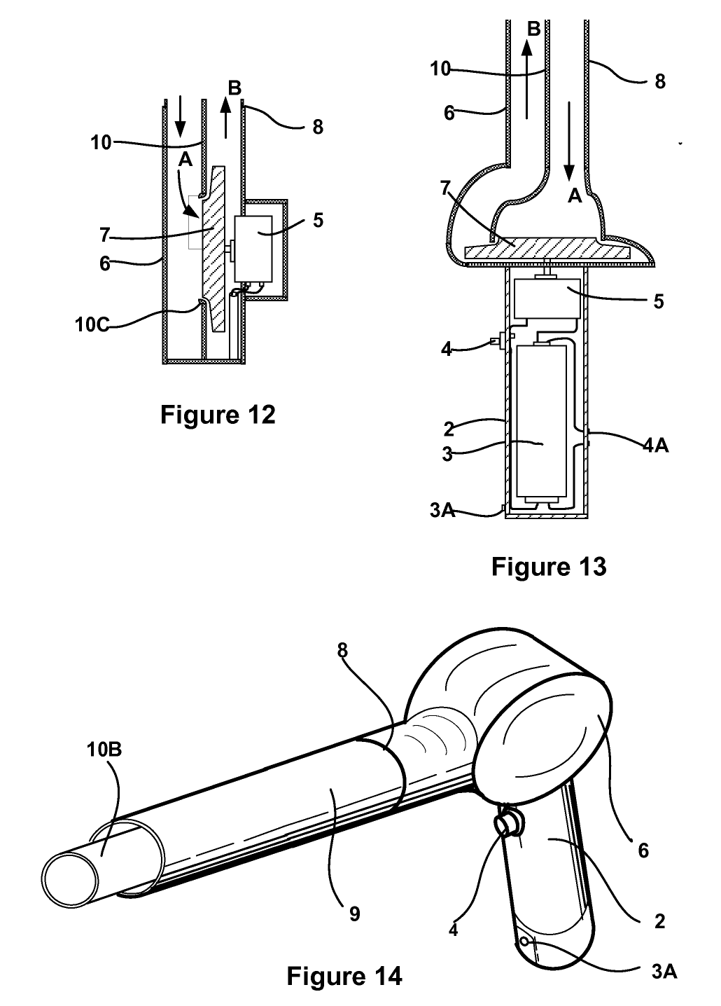

FIG. 12 shows an alternative embodiment in which the centrifugal impeller 7 is mounted with the air-outlet of said centrifugal impeller 7 facing the electric battery operated motor 5, thus allowing the electric battery operated motor 5 to be placed somewhat outside the basic housing 6 of the apparatus.

FIG. 13 shows an alternative embodiment in which the basic housing 6 is turned ninety (90) degrees so that the electric battery operated motor 5 and centrifugal impeller 7 are inline with the longitudinal length of the apparatus. Although slight alterations to the basic housing 6 are needed, the overall working of the apparatus remains unchanged.

FIG. 14 shows an alternative embodiment in which the handle 2 is adjustable so as to protrude at angles of between 0-90 degrees to the longitudinal length of the apparatus. This is done to increase the handle ability and/or shorten the total length of apparatus.

In a further alternative, where releasing an insect(s) from the apparatus would be unacceptable, for instance as would be the case with malaria carrying mosquitoes, a high voltage electrical grid may be placed in the apparatus for the swift and humane extermination of insects. E.g. covering the open end of inner tube 10B, or as a replacement for screen 17 anywhere in the air-intake area between the open end of inner tube 10B and screen 17.

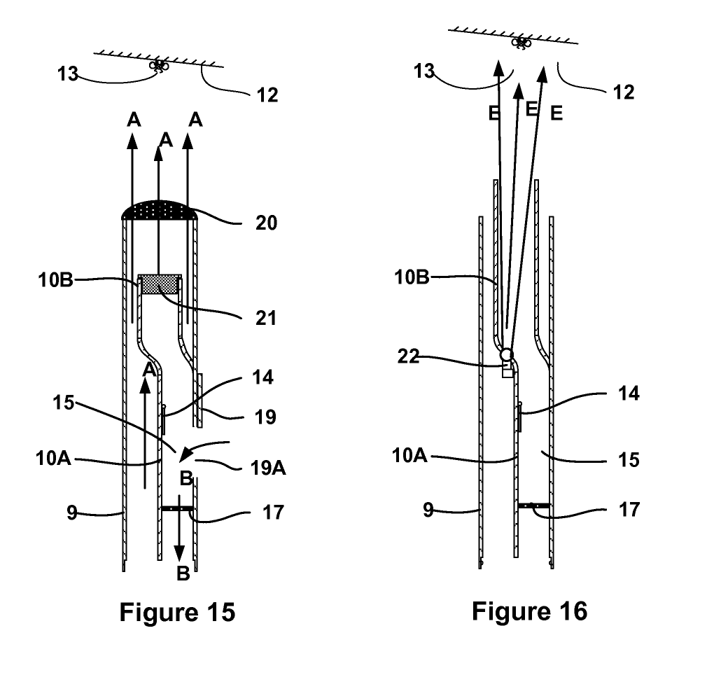

FIG. 15 shows a modified apparatus with a removable section of inner tube 10B, that has been removed and blocked with plug 21 such that inner tube 10B no longer protrudes out of outer tube 9 and no longer forms the air-intake opening of the apparatus. The air-intake opening 19A is formed by opening sliding door 19 in outer tube 9 that is situated in the vicinity of the containment area 15. Therefore only exhaust air in the form of positive air-pressure is expelled from the open end of outer tube 9. The open end of outer tube 9 is covered with a high voltage electrical grid 20. This alternative is for use with dangerous insects such as poisonous spiders or hornets etc. When the insect is pinned to a surface by the positive air-pressure, the high voltage electrical grid 20 is then brought into contact with the insect, thus humanely exterminating the insect.

FIG. 16 shows a modification in which a light source 22 has been placed such that light is emitted from the open end of inner tube 10B. The light is an aid when directing the open end of inner tube 10B towards the insect to be caught, as indicated by the arrows E.

What I claim is:

1. A method for catching and collection of live none flying and flying insects on surfaces, by applying a slight amount of positive air-pressure on the insect at a distance which does not frighten the insect into flying or crawling away, the positive air-pressure is then gradually increased, having the effect of pinning the body and/or wings of the insect more and more to the surface on which it rests, this is then followed by the vacuuming of the insect into a containment area.

2. A method according to claim 1, in which the live insect(s) can be released undamaged and unharmed by reversing the same positive air-pressure used to pin the insect to a surface, thus blowing the insect(s) undamaged out of said containment area.

3. A method according to claim 1 and 2, in which there is provided a method of collecting live insects into a containment area and then releasing the insects from said containment area, without the operator having to touch the containment area.

4. An apparatus according to claims 1, 2, and 3, comprising a basic housing with an impeller, an electrical motor attached to said impeller, an electrical power source to drive said motor, with one partitioned area on the air-intake side of said impeller and a separate partitioned area on the air-exhaust side of said impeller, the positive airflow created by said impeller is channelled through said partitioned area on the air-exhaust side of said impeller through an elongated housing with an opening at the end of said elongated housing, the negative airflow created by said impeller is channelled through said separate partitioned area on the air-intake side of said impeller such that the open end of said separate partitioned area extends outward and through the positive airflow opening.

5. An apparatus according to claim 4, in which there is provided a containment area for the containment of insects, consisting of a two-directional valve that is forced open by air-pressure during the catching or releasing of insects and closed when the apparatus is turned off, and a screen that allows air to flow through the containment area for the trapping of insects but obstructs the passage of insects to said basic housing.

6. An apparatus according to claims 4 and 5, in which there is provided a swift and easy method of changing from the insect catching position to the insect release position, by means of a close-fitting but freely rotatable connection situated in the elongated housing, between the impeller housing and the containment area, such that when the elongated housing is turned 180 degrees the original air-exhaust area of the basic housing is aligned with the air-intake area of the elongated housing, and the air-intake area of the basic housing is aligned with the air-exhaust area of the elongated housing, thus reversing the airflow through the upper section of said apparatus, due to which the airflow through said containment area is reversed, allowing insects to be blown out of said containment area.

7. An apparatus according to claim 6, in which the method used for changing from the insect catching position to the insect release position is also used for changing from insect release position to the insect catching position.

8. An apparatus according to all previous claims, in which the upper section of the apparatus is elongated by means of fixed, flexible or telescopic extensions.

9. An apparatus according to all previous claims, in which there is provided a light source attached to or incorporated into the apparatus, which directs light towards the insect, thus serving as a directional aid to the user when directing the open end of the insect catching apparatus towards the insect.

10. An apparatus according to all previous claims, in which adjustable openings are made in both air-intake area and air-exhaust area allowing for adjustment of both air-intake and air-exhaust.

11. An apparatus according to all previous claims, in which the open end of said separate partitioned area is shortened so as not to extend outward and through the positive airflow opening, said opening being blocked, with a new air-intake being formed by an opening situated in the air intake area of the apparatus, with the open end of the positive airflow opening is covered with a high voltage electrical grid, which humanely exterminates the insect when brought into contact with said insect.

12. An apparatus according to all previous claims, in which either positive air-pressure and or negative air-pressure, or both are produced by non electrical means, such as mechanical pumps or inhalation and exhalation by means of human lungs.

13. An apparatus according to all previous claims, in which the handle is adjustable at any angle to the main body of the apparatus.
